(19) United States
(12) Patent Application Publication
(10) Pub. No.: US 2025/0378304 A1
(43) Pub. Date: Dec. 11, 2025

(54) SYSTEM AND METHOD FOR GENERATING AND COMMUNICATING KNOWLEDGE FROM SENSITIVE, PRIVATE, PROTECTED OR ACCESS-RESTRICTED DATASETS

(71) Applicant: Michael Mackenzie Williams, New York, NY (US)

(72) Inventor: Michael Mackenzie Williams, New York, NY (US)

(21) Appl. No.: 18/738,805

(22) Filed: Jun. 10, 2024

(51) Int. Cl. G06N 3/042; G06N 3/045

(52) U.S. Cl. CPC G06N 3/042; G06N 3/045

(57) ABSTRACT

A Generative Knowledge Engine (GKE) is a system and method for generating valuable knowledge about Sensitive, Private, Protected or Access-Restricted Datasets (SPPARDs) while remaining in compliance with rules pertaining to the sharing of information and inferences about the data therein. The GKE comprises a system of Large Language Models (LLMs) pre-trained on rules applicable to the sharing of information and inferences about SPPARDs. There are two types of these pre-trained LLMs with specialized roles in the system. One is specialized in SPPARDs, for the purpose of generating and sharing derivative knowledge compliantly. The second is specialized in processing queries, including receiving queries and answering them. Together, in the GKE system, the LLMs are able to extract valuable knowledge from the SPPARDs in a scalable manner while maintaining compliance with all associated SPPARD rules.

### BACKGROUND

The present invention relates to the field of artificial intelligence and, more specifically, to systems and methods for generating knowledge from Sensitive, Private, Protected or Access-Restricted Datasets using large language models while maintaining compliance with the rules pertaining to the sharing of information and inferences about the data therein.

The rapid advancement of artificial intelligence (AI) and machine learning (ML) technologies has revolutionized various industries, enabling the extraction of valuable insights from vast amounts of data. However, traditional AI and ML approaches face significant challenges maintaining compliance with the rules pertaining to sharing information and inferences when working with Sensitive, Private, Protected or Access-Restricted Datasets (SPPARDs).

Existing solutions for maintaining compliance when working with SPPARDs have historically been unable to work with them in a way that is both scalable and compliant. For instance, while there are some existing businesses that effectively monetize SPPARDs of user data via user-populated surveys, users are required to answer questions manually without the help of automated knowledge generation from uploaded documentation, which is not scalable. In contrast, large technology companies are known to create shadow profiles of users in a scalable manner and effectively create SPPARDs of user data by tracking their online activities. They can then monetize the SPPARDs of user data via targeted advertisements, this activity borders on non-compliance with international data privacy rules.

Large Language Models (LLMs) have emerged as a powerful tool for natural language processing and generation. LLMs are pre-trained on vast amounts of data and can generate human-like responses to prompts. However, the use of LLMs for processing SPPARDs has been limited due to concerns regarding data privacy, data ownership, and the potential inadvertent disclosure of sensitive information.

Prior art, such as the “CUSTOMIZED SPEECH PROCESSING LANGUAGE MODELS” patent (U.S. Pat. No. 9,934,777B1), discloses methods for creating user-specific language models that include internal word indexes to a word table specific to the user-specific language model. While this approach addresses the issue of updating user-specific language models when a system-wide language model is updated, it does not provide a solution for generating knowledge from SPPARDs while maintaining compliance with the rules pertaining to the sharing of information and inferences about the data therein.

Therefore, there is a need for a novel system and method that can extract valuable knowledge from SPPARDs using LLMs while ensuring compliance with the rules pertaining to the sharing of SPPARDs, and providing a scalable and efficient solution for processing such datasets.

### SUMMARY

The present invention addresses the aforementioned problems by providing a Generative Knowledge Engine (GKE) for Sensitive, Private, Protected or Access-Restricted Datasets (SPPARDs). The GKE is a software-based technology and system of Large Language Models (LLMs) engineered to generate and communicate knowledge derived from SPPARDs when prompted by an external query, such that the outputs are compliant with all relevant laws, regulations, and privacy preferences.

The GKE comprises a system of specialized LLMs, including query-specialized LLMs and SPPARD-specialized LLMs. The LLMs are pre-trained on relevant international rules, regulations, policies, compliance measures and SPPARD-owner preferences pertaining to data handling. SPPARD-specialized LLMs do not retain any SPPARD data after being trained on one or more SPPARDs as well as any stated privacy preferences of the SPPARD owners. These LLMs act as the arbiters of knowledge derived from SPPARDs as they generate knowledge about SPPARDs and share only what is compliant with the rules pertaining to the sharing of information and inferences about the data therein.

Query-specialized LLMs are responsible for receiving SPPARD-related queries from a querier, processing the queries, querying one or more SPPARD-specialized LLMs, aggregating the responses, and generating an output that satisfies the querier's query. These LLMs are trained on querier data, past queries, querier feedback on responses, and any indexed information that the SPPARD-specialized LLMs can offer compliantly.

The GKE solves the problem of extracting valuable knowledge from SPPARDs in a scalable and compliant manner. By using a system of specialized LLMs as the arbiter of information flow between SPPARDs and queriers, the GKE enables rapid, automated, and compliant knowledge sharing without compromising data privacy.

The technical components of the GKE include LLMs hosted on cloud infrastructure and pre-trained on publicly available compliance rules pertaining to the various kinds of SPPARDs. SPPARD-specialized LLMs are trained on SPPARDs and any SPPARD-owner preferences pertaining to data handling. The specific LLM model, compliance rules, and number of LLMs used in the GKE can be varied without altering the core invention.

In summary, the present invention provides a novel and efficient solution for generating knowledge from Sensitive, Private, Protected or Access-Restricted Datasets using a system of Large Language Models while maintaining compliance with the rules pertaining to the sharing of information and inferences about the data therein. The Generative Knowledge Engine enables scalable and compliant knowledge extraction and sharing, overcoming the limitations of existing approaches.

### BRIEF DESCRIPTION OF THE DRAWINGS

The various exemplary embodiments of the present invention, which will become more apparent as the description proceeds, are outlined in the following detailed description and accompanying drawings:

FIG. 1 depicts a primitive GKE for SPPARDs.

FIG. 2 depicts a GKE for SPPARDs with Multiple Queriers and SPPARDs.

FIG. 3 depicts a GKE for SPPARDs with additional SPPARDs components for query handling.

FIG. 4 outlines a process flow for query processing in GKE for SPPARDs.

### DETAILED DESCRIPTION

In the following detailed description of the preferred embodiments, reference is made to the accompanying drawings, which form a part hereof and show, by way of illustration, specific embodiments in which the invention may be practiced. It is to be understood that other embodiments may be used and structural or logical changes may be made without departing from the scope of the present invention. The following detailed description, therefore, is not to be taken in a limiting sense, and the scope of the present invention is defined by the appended claims.

The following description is provided as an enabling teaching of the present systems, and/or methods in its best, currently known aspect. To this end, those skilled in the relevant art will recognize and appreciate that many changes can be made to the various aspects of the present systems described herein, while still obtaining the beneficial results of the present disclosure. It will also be apparent that some of the desired benefits of the present disclosure can be obtained by selecting some of the features of the present disclosure without utilizing other features.

The terms “a” and “an” and “the” and similar references used in the context of describing a particular embodiment of the present invention (especially in the context of certain claims) are construed to cover both the singular and the plural. The recitation of ranges of values herein is merely intended to serve as a shorthand method of referring individually to each separate value falling within the range. Unless otherwise indicated herein, each individual value is incorporated into the specification as if it were individually recited herein.

All systems described herein can be performed in any suitable order unless otherwise indicated herein or otherwise clearly contradicted by context. The use of any and all examples, or exemplary language (for example, “such as”) provided with respect to certain embodiments herein is intended merely to better illuminate the application and does not pose a limitation on the scope of the application otherwise claimed. No language in the specification should be construed as indicating any non-claimed element essential to the practice of the application. Thus, for example, reference to “an element” can include two or more such elements unless the context indicates otherwise.

As used herein, the terms “optional” or “optionally” mean that the subsequently described event or circumstance can or cannot occur, and that the description includes instances where said event or circumstance occurs and instances where it does not.

The word or as used herein means any one member of a particular list and includes any combination of members of that list. Further, one should note that conditional language, such as, among others, “can,” “could,” “might.” or “may.” unless specifically stated otherwise, or otherwise understood within the context as used, is generally intended to convey that certain aspects include, while other aspects do not include, certain features, elements and/or steps. Thus, such conditional language is not generally intended to imply that features, elements and/or steps are in any way required for one or more particular aspects or that one or more particular aspects necessarily include logic for deciding, with or without user input or prompting, whether these features, elements and/or steps are included or are to be performed in any particular aspect.

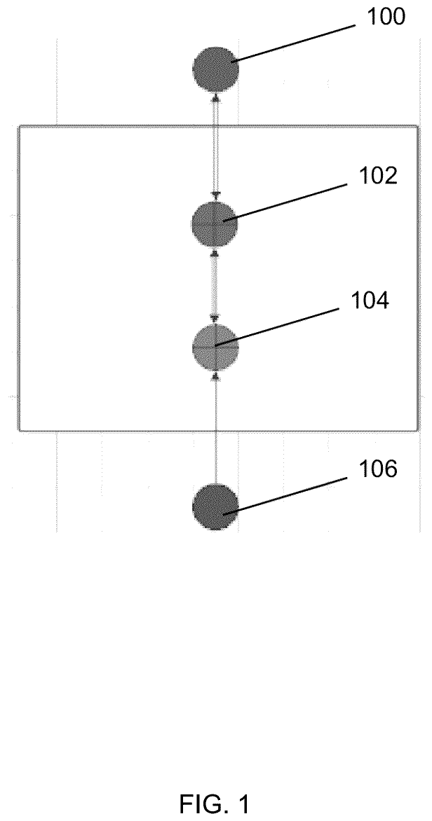

FIG. 1 illustrates a primitive embodiment of the Generative Knowledge Engine (GKE). The system comprises a network of large language models (LLMs), such as GPT-3, LaMDA, or BERT, hosted on cloud infrastructure like Amazon Web Services (AWS) or Microsoft Azure, including at least one query-specialized LLM 102 and at least one SPPARD-specialized LLM 104. The query-specialized LLM 102 is configured to receive a query from a querier 100, such as a user or software application, related to one or more SPPARDs, and process it by requesting and synthesizing responses from SPPARD-specialized LLMs, and using them to generate outputs that satisfy the queries. The SPPARD-specialized LLM 104 is associated with a SPPARD 106, such as a database containing sensitive medical records or confidential business information, and is configured to be pre-trained on data privacy rules applicable to its associated SPPARD(s), such as Health Insurance Portability and Accountability Act (HIPAA) in the U.S. and the General Data Protection Regulation (GDPR) in the E.U., and thereafter trained on its associated SPPARD (without retaining any SPPARD data), so that it can generate derivative knowledge from its associated SPPARD using techniques like transfer learning, and communicate the derivative knowledge to the query-specialized LLM 102. The query-specialized LLM 102 and the SPPARD-specialized LLM 104 communicate with each other, as indicated by the bidirectional arrows, to determine if the SPPARD 106 can be used to answer the query and if so, extract information, insights, and/or knowledge from the SPPARD to feed into the output response to the querier that complies with the data privacy rules applicable to the SPPARD.

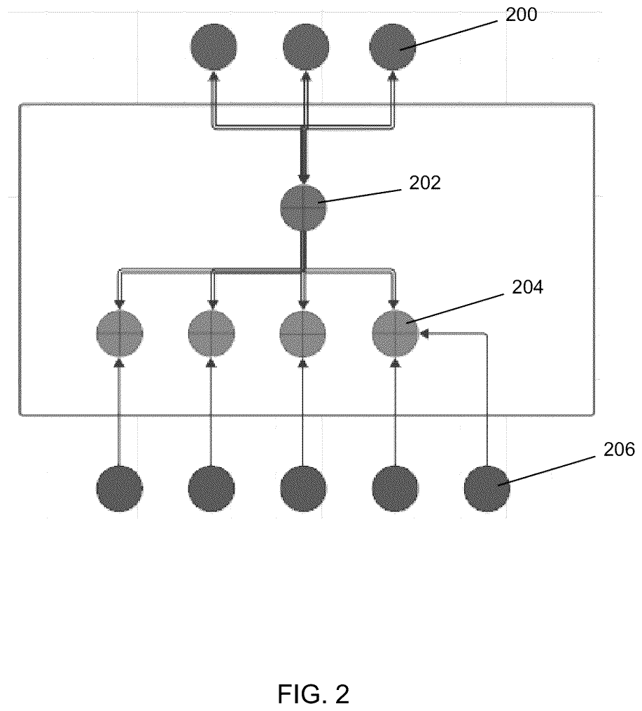

FIG. 2 depicts an expanded embodiment of the GKE system with multiple queriers 200, one query-specialized LLM 202, such as GPT-3, LaMDA, or BERT models, and multiple SPPARD-specialized LLMs 204, such as models trained on specific domains like healthcare or finance, each associated with one or more SPPARDs 206, such as databases containing electronic health records or financial transaction data. This embodiment demonstrates the scalability of the system to handle multiple queriers and SPPARDs. The query-specialized LLMs 202 and SPPARD-specialized LLMs 204 can be implemented using cloud-based infrastructure and services, enabling efficient scaling and resource allocation. One of the SPPARD-specialized LLMs 204 is shown to be associated with two SPPARDs 206, illustrating the flexibility of the system in terms of the number of SPPARDs that can be associated with each SPPARD-specialized LLM. This allows for efficient utilization of computational resources and enables the system to handle a wide variety of SPPARDs with different data structures and privacy requirements.

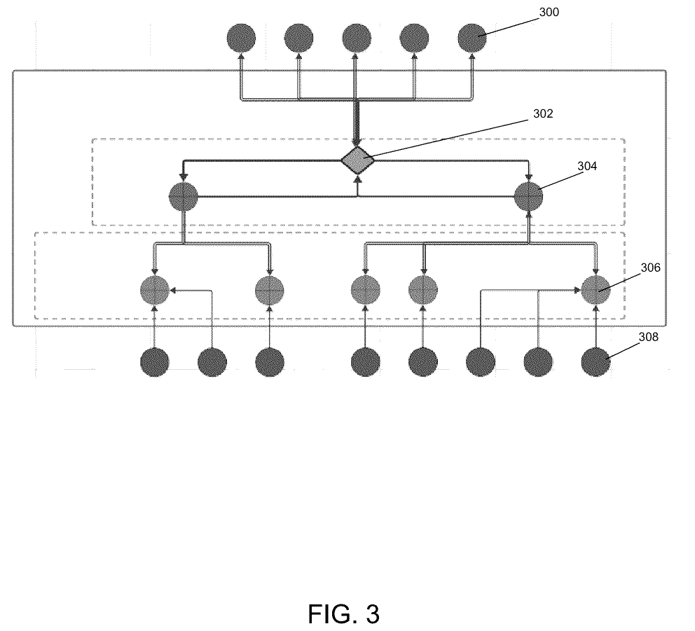

FIG. 3 presents a further developed embodiment of the GKE system, introducing additional components for enhanced query handling and system performance. The system includes multiple query-specialized LLMs 302, such as GPT-3, LaMDA, or BERT models, and a load balancer 308, which can be implemented using cloud-based load balancing services like AWS Elastic Load Balancing or Azure Load Balancer, configured to distribute queries across the query-specialized LLMs to improve system performance and scalability. The load balancer 308 receives queries from the queriers 300, such as users or software applications, and routes them to the appropriate query-specialized LLMs 302 based on factors such as LLM availability and specialization. The query-specialized LLMs 302 then interact with the SPPARD-specialized LLMs 304, such as LLMs trained on specific domains like healthcare or finance, each associated with one or more SPPARDs 306, such as databases containing electronic health records or financial transaction data, to generate output responses as described in the previous figures. The communication between the query-specialized LLMs 302 and SPPARD-specialized LLMs 304 can be implemented using secure protocols like HTTPS or SSL/TLS to ensure the privacy and integrity of the data being exchanged.

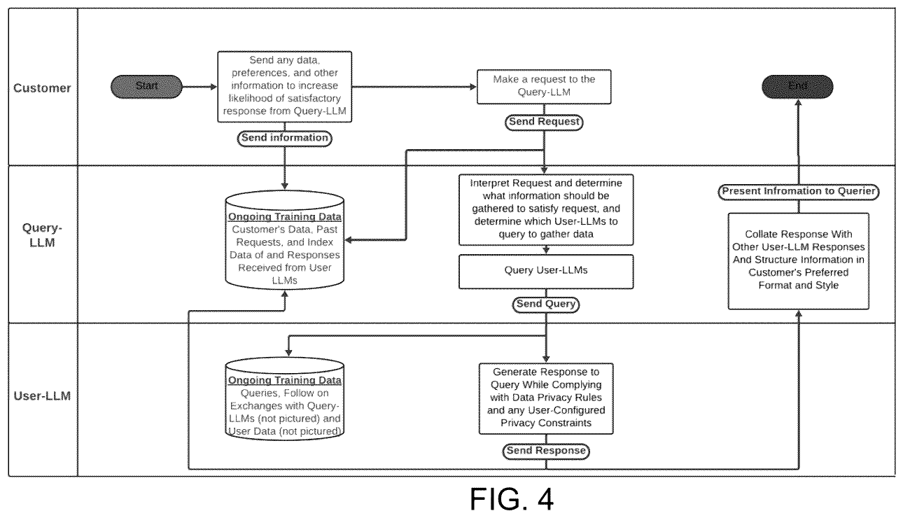

FIG. 4 illustrates a process flow diagram for the operation of the Generative Knowledge Engine (GKE) system. The process begins with the querier submitting a text query to the GKE via a user interface. In one embodiment, the user interface may be a web-based application built using a modern web development stack such as the MERN stack, which includes MongoDB for the database, Express.js for the backend web framework, React for the frontend user interface, and Node.js for the JavaScript runtime environment. The query is sent to a database to improve the ongoing training data for the query-specialized LLM and also processed by the query-specialized LLM, which may be implemented using a Generative AI architecture such as GPT-3 or BERT, and trained on a diverse corpus of text data. The query-specialized LLM interprets and adjusts the query as necessary, for example by expanding acronyms, correcting spelling errors, or rephrasing the query to better match the terminology used in the SPPARDs. The query-specialized LLM determines which SPPARD-specialized LLMs to contact based on the query's relevance to the associated SPPARDs. This relevance determination may be performed using techniques such as keyword matching, semantic similarity analysis, or topic modeling. The adjusted query is then sent to be stored as part of the corpus of ongoing training data for the SPPARD-specialized LLMs and also sent to the selected SPPARD-specialized LLMs, which are implemented using large language models and trained on the specific data contained in their associated SPPARDs. The SPPARD-specialized LLMs generate derivative knowledge from their associated SPPARDs in compliance with applicable data privacy rules. For example, the LLMs may be configured to never output verbatim copies of text from the SPPARDs, and to only generate novel text that summarizes or synthesizes the relevant information. The generated knowledge is communicated back to the query-specialized LLM, which collates the responses and generates a final output response for the querier. The final response may be presented to the querier via the user interface. As mentioned throughout the process, ongoing training data, including querier data, past requests, and an index of revised responses, is collected and used to update the pre-training of the query-specialized LLM and SPPARD-specialized LLMs. This allows the GKE system to continuously improve its performance and adapt to changes in the queriers' needs and the contents of the SPPARDs.

The embodiments described herein are given for the purpose of facilitating the understanding of the present invention and are not intended to limit the interpretation of the present invention. The respective elements and their arrangements, materials, conditions, shapes, sizes, or the like of the embodiment are not limited to the illustrated examples but may be appropriately changed. Further, the constituents described in the embodiment may be partially replaced or combined together.

What is claimed is:

1. A method for generating and communicating knowledge from Sensitive, Private, Protected or Access-Restricted Datasets (SPPARDs) comprising:
pre-training a plurality of large language models (LLMs) hosted on cloud infrastructure, the pre-training including:
pre-training at least one query-specialized LLM on data privacy rules, querier data, past queries, and querier feedback; and
pre-training at least one SPPARD-specialized LLM for each of one or more SPPARDs on data privacy rules applicable to its associated SPPARD;
training each SPPARD-specialized LLM on its associated SPPARD without retaining any SPPARD data;
receiving, by the at least one query-specialized LLM, a query from a querier related to the one or more SPPARDs;
processing, by the at least one query-specialized LLM, the query to determine which of the one or more SPPARDs are relevant to the query;
generating, by each SPPARD-specialized LLM, derivative knowledge from its associated SPPARD;
communicating the derivative knowledge from each SPPARD-specialized LLM to the at least one query-specialized LLM; and
generating, by the at least one query-specialized LLM, an output response to the querier based on the derivative knowledge received from the at least one SPPARD-specialized LLM for each of the one or more SPPARDs determined to be relevant to the query, the output response complying with the data privacy rules applicable to the one or more relevant SPPARDs.

2. The method of claim 1, further comprising pre-training of the at least one query-specialized LLM further includes pre-training on indexed information provided by the at least one SPPARD-specialized LLM.

3. The method of claim 1, wherein the processing of the query by the at least one query-specialized LLM includes querying the at least one SPPARD-specialized LLM to determine relevance to the query.

4. The method of claim 1, wherein the generating of derivative knowledge by each SPPARD-specialized LLM includes inferring new knowledge from its associated SPPARD without violating any rules applicable to the SPPARD.

5. The method claim 1, wherein the data privacy rules applicable to the one or more SPPARDs include at least one of laws, regulations, policies, or owner-specified privacy preferences.

6. The method of claim 1, wherein the communicating of the derivative knowledge from each SPPARD-specialized LLM to the at least one query-specialized LLM is performed in a manner that maintains compliance with the applicable data privacy rules.

7. The method of claim 1, further comprising providing the output response generated by the at least one query-specialized LLM to the querier.

8. The method of claim 1, wherein the at least one query-specialized LLM and the at least one SPPARD-specialized LLM are implemented using different LLM architectures specialized for their respective functions.

9. The method of claim 1, further comprising updating the pre-training of the at least one query-specialized LLM based on feedback received from the querier regarding the output response.

10. The method of claim 1, wherein the one or more SPPARDs include datasets containing personal data protected by data privacy regulations.

11. The method claim 1, further comprising load balancing queries across a plurality of query-specialized LLMs to improve system performance and scalability.

12. The method of claim 1, wherein the derivative knowledge generated by each SPPARD-specialized LLM is represented in a structured format to facilitate communication to and utilization by the at least one query-specialized LLM.

13. The method of claim 1, further comprising implementing access controls to restrict querier access to the GKE system based on querier authorization levels.

14. A system for generating and communicating knowledge from Sensitive, Private, Protected or Access-Restricted Datasets (SPPARDs) comprising:
at least one processor;
at least one memory including computer program code for one or more programs;
a plurality of LLMs hosted on cloud infrastructure, the plurality of LLMs including:
at least one query-specialized LLM configured to:
receive a query from a querier related to one or more SPPARDs, process the query to determine which of the one or more SPPARDs are relevant to the query, and
generate an output response to the querier based on knowledge derived from the one or more relevant SPPARDs; and
at least one SPPARD-specialized LLM for each of the one or more SPPARDs, each SPPARD-specialized LLM configured to:
be pre-trained on data privacy rules applicable to its associated SPPARD, train on its associated SPPARD without retaining any SPPARD data, generate derivative knowledge from its associated SPPARD, and communicate the derivative knowledge to the at least one query-specialized LLM;
wherein the at least one query-specialized LLM and the at least one SPPARD-specialized LLM for each of the one or more SPPARDs are configured to communicate with each other to generate the output response to the querier that is derived from the one or more SPPARDs and complies with the data privacy rules applicable to the one or more SPPARDs.

15. The system of claim 14, wherein the at least one query-specialized LLM is further configured to be pre-trained on querier data, past queries, and querier feedback.

16. The system of claim 14, wherein the at least one query-specialized LLM is further configured to be pre-trained on indexed information provided by the at least one SPPARD-specialized LLM.

17. The system of claim 14, wherein the at least one query-specialized LLM is further configured to query the at least one SPPARD-specialized LLM to determine relevance to the query during processing of the query.

18. The system of claim 14, wherein each SPPARD-specialized LLM is further configured to infer new knowledge from its associated SPPARD without revealing any of the SPPARD data when generating the derivative knowledge.

19. The system of claim 14, wherein the data privacy rules applicable to the one or more SPPARDs include at least one of laws, regulations, policies, and owner-specified privacy preferences.

20. The system of claim 14, wherein each SPPARD-specialized LLM is further configured to communicate the derivative knowledge to the at least one query-specialized LLM in a manner that maintains compliance with the applicable data privacy rules.

21-27. (canceled)
